(19) United States
(12) Patent Application Publication
(10) Pub. No.: US 2016/0053486 A1
(43) Pub. Date: Feb. 25, 2016

(54) PANEL FOR A BUILDING STRUCTURE, A BUILDING SYSTEM AND A BUILDING STRUCTURE HAVING THE BUILDING PANEL

(71) Applicant: EAA RESEARCH ENGINEER PTY LTD, North Rocks, New South Wales (AU)

(72) Inventor: Edgar A. AGDA, North Rocks, New South Wales (AU)

(21) Appl. No.: 14/780,548

(22) PCT Filed: Apr. 30, 2013
(86) PCT No.: PCT/AU2013/000443

§ 371 Date: Sep. 27, 2015

(30) Foreign Application Priority Data
Mar. 27, 2013 (AU) 2013901055

(51) Int. Cl. E04B 2/86; E02D 27/01; F16L 5/00; E04G 11/06; E04G 25/00

(52) U.S. Cl. CPC E04B 2/86; E04B 2/8652; E04G 11/062; E04G 25/00; F16L 5/00; E02D 27/01; E04B 2002/0256

(57) ABSTRACT

A building panel includes a substantially planar first side and a second side having at least one formation. Each formation includes a work surface spaced form the first side.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE ON MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to a panel for a building structure, a building system and a building structure having the building panel.

The invention has been developed primarily for the construction industry and will be described hereinafter with reference to this application. However, it will be appreciated that the invention is not limited to this particular field of use.

2. Description of Related Art Including Information Disclosed Under 37 CFR 1.97 and 37 CFR 1.98.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a building panel comprising:
a substantially planar first side; and
a second side having at least one formation, each formation comprising a work surface spaced from the first side.

Preferably, the building panel comprises a plate body having a first side and an opposite second side, wherein the at least one formation extends from the second side.

Preferably, the first side comprises a flat planar surface.

In another embodiment, the first side comprises a curved surface.

Preferably, each formation comprises an elongated formation.

Preferably, each formation comprises a longitudinal formation.

Preferably, the building panel comprises at least two spaced longitudinal formations extending along the second side.

Preferably, the at least two spaced longitudinal formations are parallel.

Preferably, each formation extends between ends of the plate body and spaced laterally between lateral edges of the plate body.

Preferably, the formations are disposed symmetrically about a center line extending between ends of the panel body.

Preferably, the formations comprise two first formations adjacent the respective lateral edges of the plate body.

Preferably, the formations further comprise two second formations respectively spaced inwardly from the first formations.

Preferably, each longitudinal formation comprises a channel section having spaced side portions extending from the second side and a band portion extending between the side portions, the band portion defining the work surface.

Preferably, the side portions extend substantially perpendicularly from the second side.

In another embodiment, the side portions extend in a substantially diverging manner from the second side.

In another embodiment, the side portions extend in a substantially converging manner from the second side.

In another embodiment, the side portions extend at an inclined angle from the second side.

Preferably, the band portion is substantially parallel to the first side.

Preferably, the building panel further comprises a plurality of spaced apertures formed in the building panel extending from the first side to the second side.

Preferably, the building panel comprises spaced central apertures formed along a centre line of the panel.

Preferably, the building panel comprises spaced side apertures formed between the formations.

Preferably, the building panel further comprises at least one service line aperture formed in the at least one formation, the service line formation extending in a generally lateral direction of the panel.

Preferably, the at least one service line aperture is formed in the side portions of the formations.

Preferably, the building panel is 450 mm to 600 mm wide. Preferably, the building panel is about 1200 mm long.

Preferably, the building panel has a thickness of about 60 mm between the first side and the work surface.

In another embodiment, the building panel is between 75 mm to 300 mm wide and comprises two elongated formations extending along lateral sides thereof

In another embodiment, the building panel is between 75 mm to 300 mm wide and comprises at least one elongated formation extending adjacent one lateral side only thereof.

Preferably, the building panel comprises a plurality of spaced work surfaces. Preferably, the first side comprises a solid surface.

Preferably, the second side comprises a solid surface from which the at least one formation extends.

Preferably, the panel is substantially rigid.

In another embodiment, at least one of the formations extends outwardly from a lateral edge of the panel.

In another embodiment, the plate body includes a central folded formation which extends in the same direction as the at least one formation.

According to another aspect, the present invention provides a building system comprising:
at least one building panel according to any one of the above; and
an elongated footing having a channel for receiving an end portion of the at least one building panel.

Preferably, the footing comprises a substantially J-shape cross-section.

Preferably, the building system further comprises a panel joiner defining first and second outwardly directed channels oriented perpendicularly to each other.

Preferably, the building system further comprises a panel joiner defining first and second outwardly directed channels oriented at generally opposing directions.

Preferably, the building system further comprises a panel joiner defining first and second outwardly directed channels oriented at about 135° relative to each other.

According to another aspect, the present invention provides a method of building a wall using the building system of the above, the method comprising:
mounting to a first footing to a concrete floor slab or ground; and mounting a first building panel into the first footing.

Preferably, the method further comprises mounting a second footing to the concrete floor slab or ground, spaced and substantially parallel to the first footing; and
mounting a second building panel into the second footing, the first side of the second panel facing the first side of the first panel.

Preferably, the method further comprises joining the first and second building panels via at least one joining rod.

Preferably, the at least one joining rod comprises a threaded rod and a spacer received by the threaded rod disposed between the building panels.

Preferably, the method further comprises disposing a reinforcement mesh between the first and second panels, the reinforcement mesh being spaced from the first sides of the first and second building panels.

Preferably, the method further comprises pouring concrete between the building panels.

Preferably, the method further comprises mounting a further generally vertical building panel to the first building panel via a panel joiner defining first and second outwardly directed channels oriented at generally opposing directions, the channels receiving respective ends of the first panel and the further panel.

Preferably, the method further comprises mounting a further generally horizontal building panel to the first building panel via a panel joiner defining first and second outwardly directed channels oriented perpendicularly to each other, the channels receiving respective ends of the first panel and the further panel.

Preferably, the method further comprises pouring concrete on top of the generally horizontal building panel to form an elevated floor slab.

Preferably, the method further comprises mounting a further inclined building panel to the first building panel via a panel joiner defining first and second outwardly directed channels oriented at about 135° relative to each other, the channels receiving respective ends of the first panel and the further panel.

Preferably, the method further comprises mounting an additional inclined building panel spaced and parallel to the further building panel, and pouring concrete between the additional and further building panels.

Preferably, the method further comprises adding cladding adjacent the work surfaces of the building panels.

According to another aspect, the present invention provides a building structure comprising:
a concrete wall having the building panel of the above on at least one side thereof

Preferably, the building structure comprises a concrete wall and two building panels of the above on each side thereof

Preferably, the building structure comprises two spaced concrete walls each having the building panel of the above on at least one side thereof and an elevated concrete floor extending between the spaced walls, the concrete floor having the building panel of the above on a lower side thereof.

Preferably, the concrete of the walls and the elevated floor together to form a generally monolithic structure.

Preferably, the building structure comprises cladding adjacent the work surface of the at least one building panel.

Preferably, the cladding comprises Magnesium Oxide wallboards, plasterboard, metal sheet, plywood and/or a brick wall

Preferably, the first side of the building panel comprises bonding means to assist with bonding or attachment to concrete.

Preferably, the bonding means comprises stippling, a roughened surface, protrusions an/or projections.

According to another aspect, the present invention provides a building panel comprising a generally corrugated body having spaced dovetail shaped channels formed therein, wherein adjacent channels face alternating sides of the body.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows a first 600 mm building panel in accordance with a preferred embodiment of the present invention, where (a) is a front view, (b) is a side view; and (c) is an end view.

FIG. 2 is shows a footing for the building system of the present invention, where (a) is a perspective view and (b) is an end view.

FIG. 3 shows end views of different panels, a footing and joiners for the building system according to the present invention where (a) is a 600 mm panel, (b) is a 450 mm panel, (c) is a 300 mm panel, (d) is a 150 mm panel, (e) is a 100 mm panel, (f) is a 75 mm panel, (g) is a 300 mm half-panel, (h) is a 200 mm half-panel, (i) is a 100 mm half-panel, (j) is a first 300 mm alternative panel, (k) is a second 300 mm alternative panel, (l) is a third 300 mm alternative panel, (m) is the footing of FIG. 2, (n) is a first 90° joiner, (o) is a straight 180° joiner, (p) is a second 90° joiner, and (q) is a 135° joiner.

FIGS. 4 to 10 illustratively show schematic views of the steps in building a wall and an elevated floor slab for a building structure according to a preferred embodiment of the present invention.

FIG. 11 is a side cross-section view of a wall of the building structure.

FIGS. 12 to 18 illustratively show schematic views of the steps in building a building structure according to a preferred embodiment of the present invention.

FIG. 19 (a) to (e) show cross-sectional views of alternative wall structures to that shown in FIG. 11.

FIG. 20 shows schematic views of the steps in forming the building panel of FIG. 3(a).

FIG. 21 shows schematic views the steps in forming the building panel of FIG. 3(b).

FIG. 22 shows schematic views the steps in forming the building panel of FIG. 3(c).

FIG. 23 shows schematic views the steps in forming the building panel of FIG. 3(d).

FIG. 24 shows schematic views the steps in forming the building panel of FIG. 3(e).

FIG. 25 shows schematic views the steps in forming the building panel of FIG. 3(f).

FIG. 26 shows schematic views the steps in forming the building panel of FIG. 3(g).

FIG. 27 shows schematic views the steps in forming the building panel of FIG. 3(h).

FIG. 28 illustrates schematic views of some of the advantages of the present building system.

FIG. 29 shows a finished building structure made according to the preferred embodiment, being a granny flat (secondary suite), where (a) is a front elevation, (b) is a section elevation, (c) is a ground floor plan and (d) is an upper floor plan.

FIG. 30 shows a schematic view of an alternative use of the building panels of the present invention as a bushfire (wildfire) shield.

FIG. 31 shows an end view of (a) stair step building panel and (b) a stair side form panel.

FIG. 32 (a) to (j) show schematic views the steps in building stairs using the building panels of FIG. 31.

FIG. 33 shows an end view of an internal partition building panel with a reinforcing bar.

FIG. 34 shows an end view of a finished internal partition.

FIG. 35 (a) to (e) show schematic views of the steps in building an internal partition using the building panel of FIG. 33.

FIG. 36 shows an end view of an external render building panel with a reinforcing bar.

FIG. 37 shows an end view of a finished external render.

FIG. 38 (a) to (c) show schematic views the steps in building an external render using the building panel of FIG. 36.

### DETAILED DESCRIPTION OF THE INVENTION

It should be noted in the following description that like or the same reference numerals in different embodiments denote the same or similar features.

FIG. 1 shows a first 600 mm wide building panel 50 according to a preferred embodiment of the present invention. The building panel 50 comprises a rectangular plate body 52 having four spaced longitudinal formations 60 along one side thereof.

The plate body 52 comprises a flat first side 53, an opposite flat second side 54, ends 55, and lateral edges 56. The first side 53 comprises a flat planar surface 58. The four spaced longitudinal formations 60 are disposed along the second side 54, each extending between the ends 55 and spaced laterally between the lateral edges 56.

The four formations 60 are disposed symmetrically about a center line extending between the ends 55 of the second side 54. The formations 60 comprise two first formations 60a adjacent the respective lateral edges 56 and two second formations 60b spaced inwardly from the first formations 60a.

Each longitudinal formation 60 in the embodiment generally comprises a channel section having spaced side portions 62 extending perpendicularly from the second side 54 and a band portion 64 extending parallel to the second side 54, and thus spaced and parallel to the planar surface 58. The band portion 64 defines a work surface spaced from the first side 53.

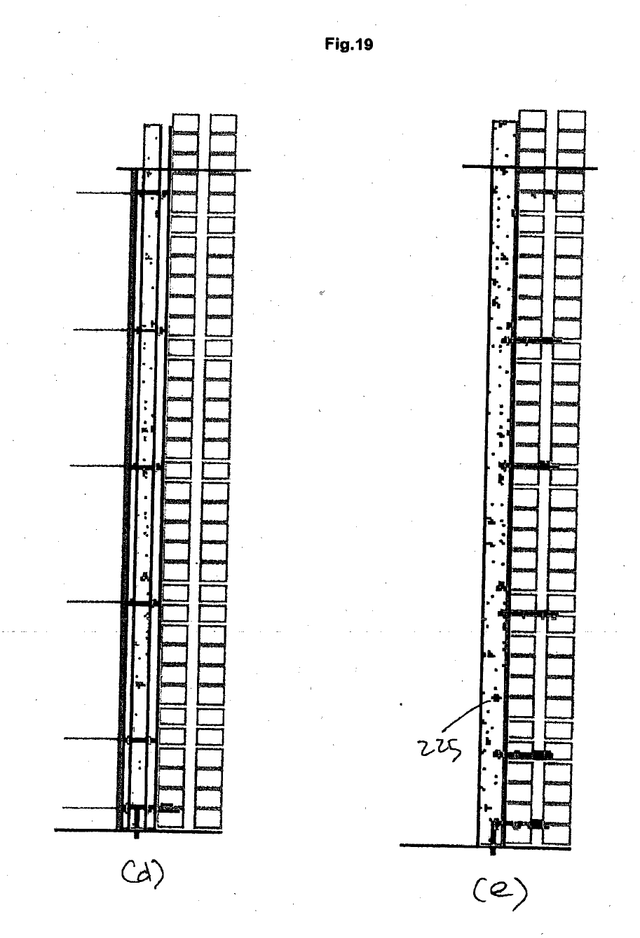

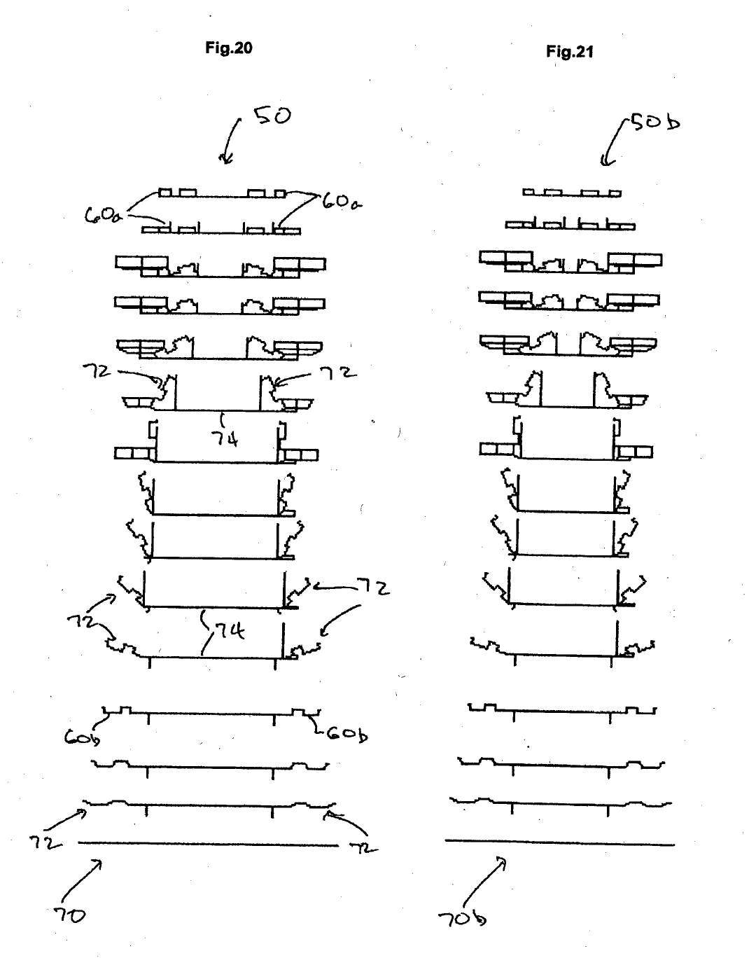

FIG. 20 shows the series of folding steps in forming the building panel 50 from a single flat piece 70 of sheet metal. Starting from a flat piece 70 of sheet metal at the bottom of FIG. 20, the series of folding steps is shown (moving upwardly in FIG. 20) starting with folding of side sections 72 of the flat piece 70 to form the formations 60b, and then folding the side sections 72 toward a central section 74 of the second side 54 to form the formations 60a. These folding steps can be performed via a metal folding machine. The formations 60 act as ribs and strengthen the building panels 50.

Referring back to FIG. 1, portions of the side sections 72 adjacent the second side 54 are joined thereto via a metal clinching process at spaced points 76, such as by use of the TOG-L-LOC™ (registered) machine and process. This forms the general structure of the building panel 50.

A number of spaced rod apertures 78 are formed in the building panel 50 extending from the first side 53 to the second side 54. Central apertures 78a are formed along the centre 25 line of the second side 54 and side apertures 78b are formed respectively between the formations 60a and 60b. A number of spaced service line apertures 79 are also formed in the side portions 62 of the formations 60. The apertures 79 of the formations 62 are respectively aligned and extend between the lateral edges 56.

In the embodiment, the building panel 50 is 600 mm wide between the lateral edges 56, 1200 mm long between the ends 55 and 60 mm thick between the planar surface 58 and the band portions 64.

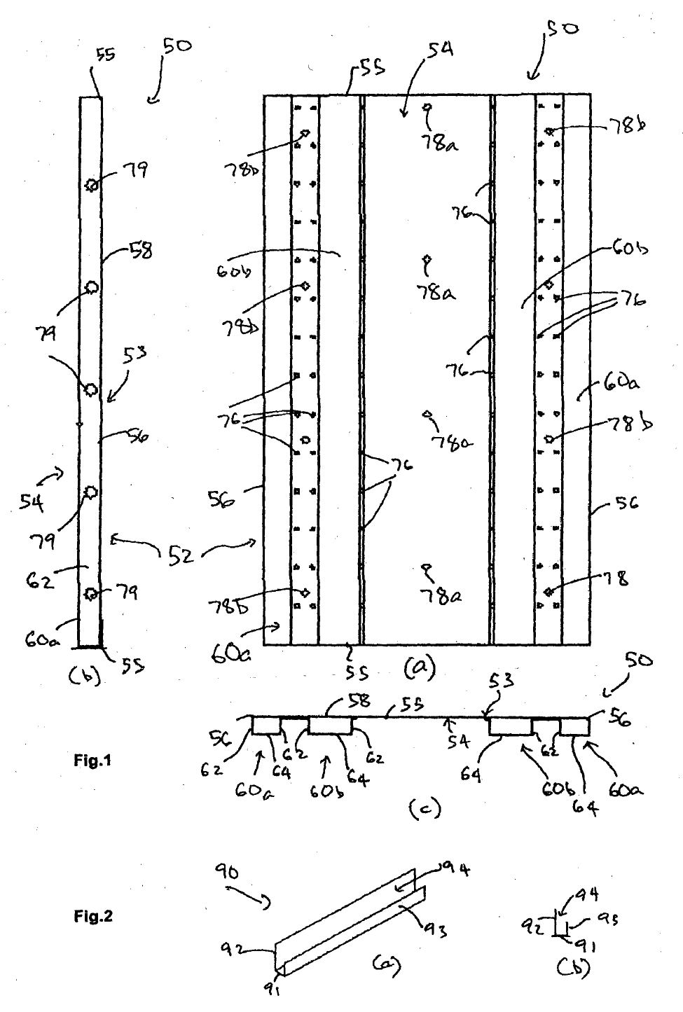

FIG. 2 is shows a footing 90 for the building system of the present invention. The footing 90 is generally J-shaped in cross-section and comprises a base portion 91 and first and second upwardly extending side portions 92 and 93 which respectively extend from longitudinal edges of the base portion 91, to define a channel 94 therebetween. The first side portion 92 extends longer than the second side portion 93 from the base portion 91.

The footing 90 is 600 mm wide and the channel 94 is slightly over 60 mm wide between the side portions 92 and 93.

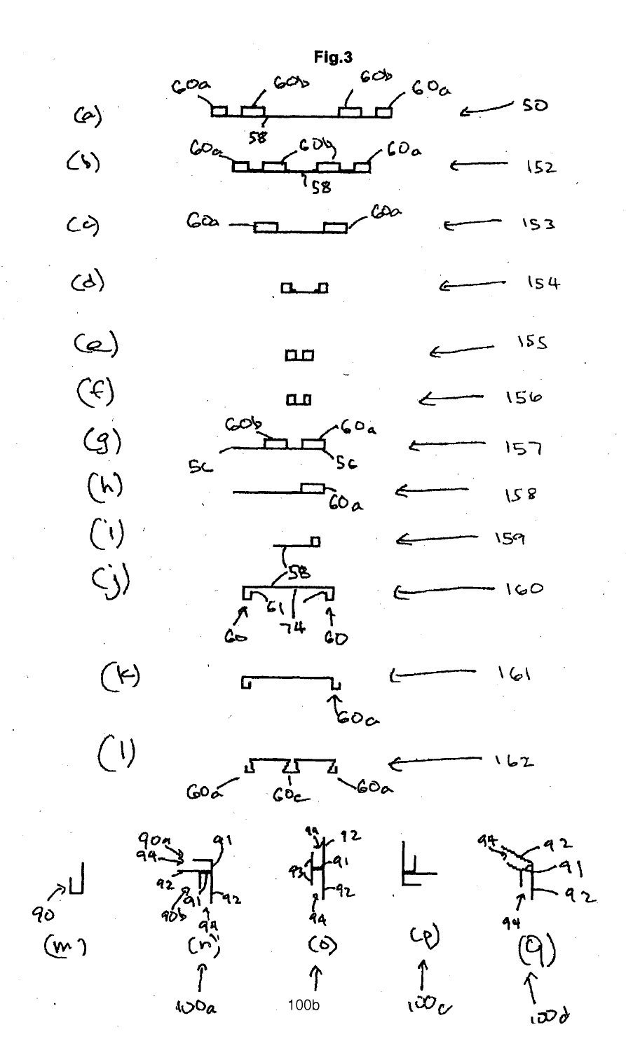

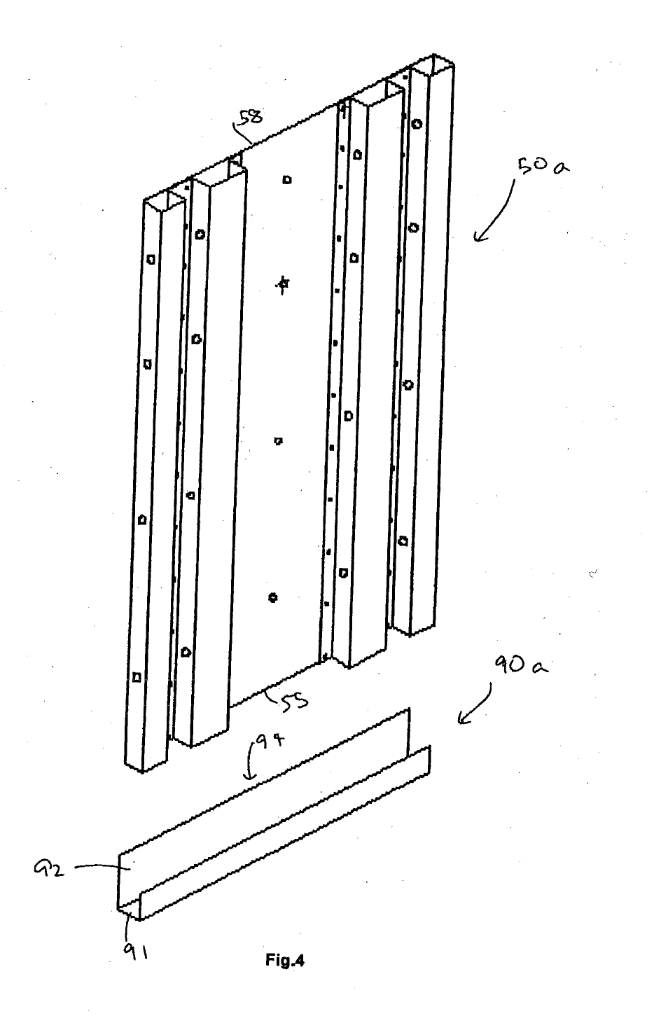

FIG. 3 shows end views of different panels, a footing and joiners for the building system according to the present invention. FIG. 3(a) shows the building panel 50.

FIG. 3(b) shows a building panel 152, which is similar to the building panel 50 except that the building panel 152 is 450 mm wide. The building panel 152 also comprises the formations 60a and 60b. FIG. 21 shows the series of steps in forming the building panel 152 from a flat piece 70b of sheet metal.

FIG. 3(c) shows a building panel 153, which is also similar to the building panel 50 except that the building panel 153 is 300 mm wide and only includes the formations 60a.

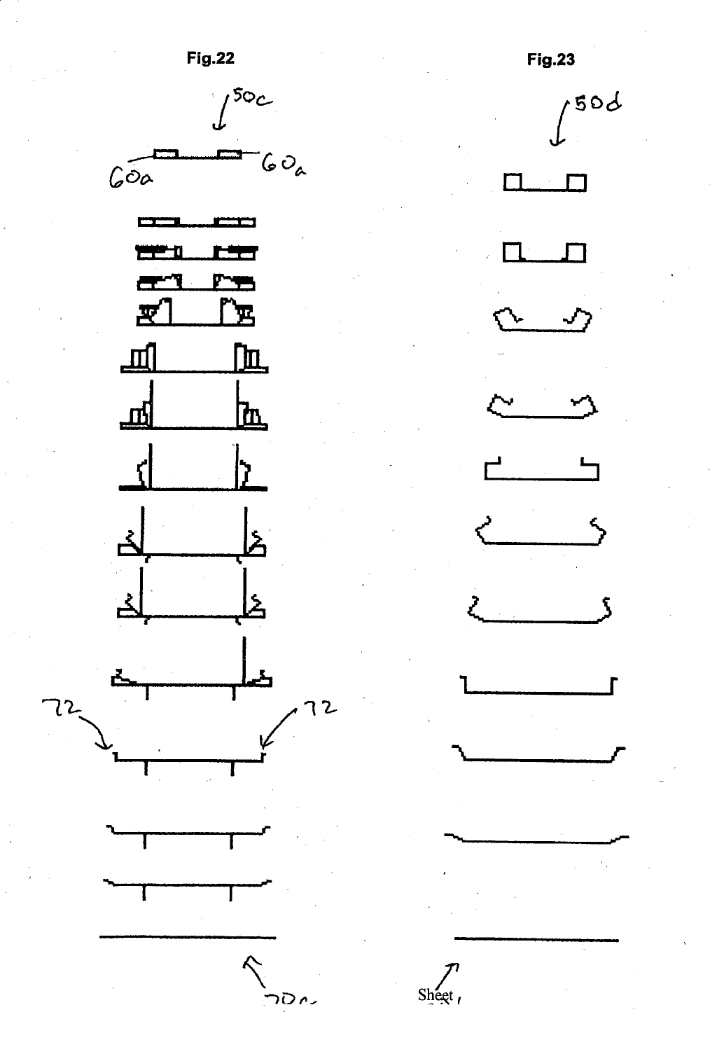

FIG. 22 shows the steps in forming the building panel 153 from a flat piece 70c of sheet metal. It can be seen that the side sections 72 are folded toward the central section 74 to form the formations 60a.

FIG. 3(d) shows a building panel 154, which is similar to the building panel 153 except that the building panel 154 is 150 mm wide. FIG. 23 shows the steps in forming the building panel 154 from a flat piece 70d of sheet metal.

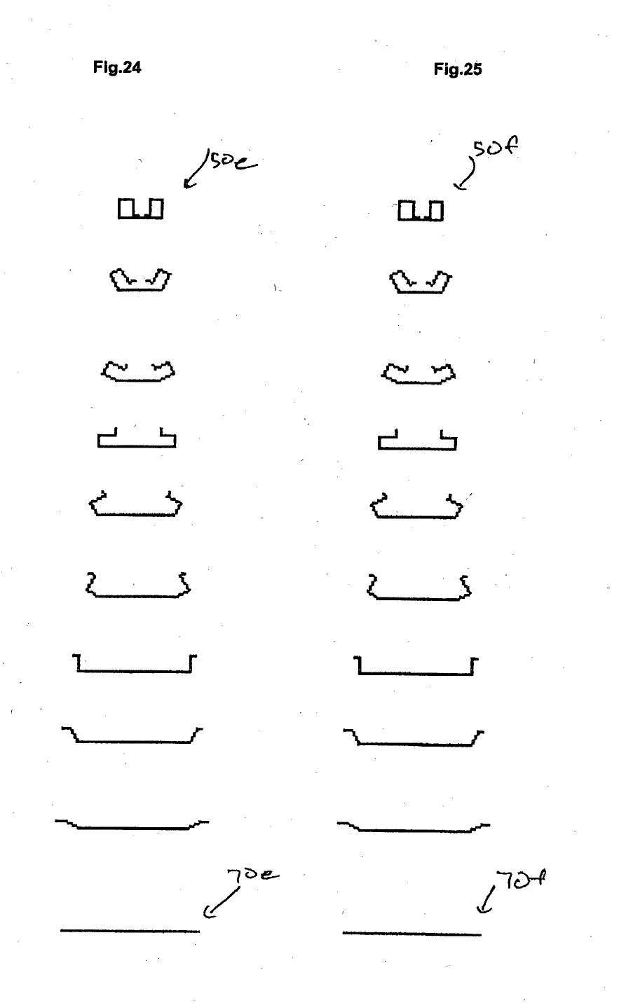

FIG. 3(e) shows a building panel 155, which is similar to the building panel 154 except that the building panel 155 is 100 mm wide. FIG. 24 shows the steps in forming the building panel 155 from a flat piece 70e of sheet metal.

FIG. 3(f) shows a building panel 156, which is similar to the building panel 155 except that the building panel 156 is 75 mm wide. FIG. 25 shows the steps in forming the building panel 156 from a flat piece 70f of sheet metal.

FIG. 3(g) shows a building panel 157, which is similar to the building panel 50a except that the building panel 157 is essentially a half-panel of the building panel 50a. The building panel 157 is 300 mm wide and only includes one pair of formations 60a and 60b at one lateral edge 56 thereof, with the other lateral edge 56 being free of formations 60.

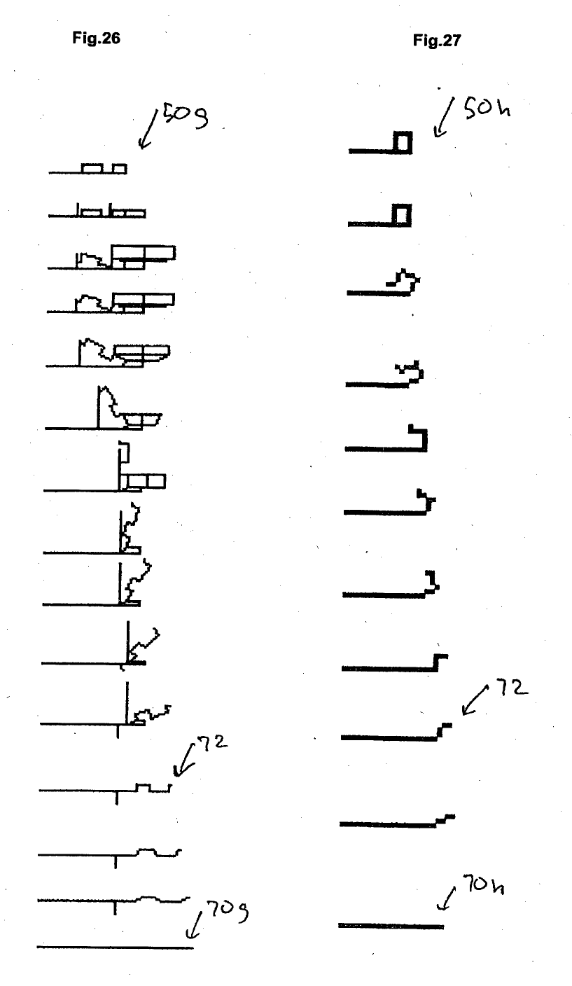

FIG. 26 shows the steps in forming the building panel 157 from a flat piece 70g of sheet metal, at which only one of the side sections 72 is folded.

FIG. 3(h) shows a building panel 158, which is similar to the building panel 157 except that the building panel 158 is only 200 mm wide and only includes one formation 60a.

FIG. 27 shows the steps in forming the building panel of 158 from a flat piece 70h of sheet metal.

FIG. 3(i) shows a building panel 159, which is similar to the building panel 158 except that the building panel 159 is only 150 mm wide.

FIG. 3(j) shows a first 300 mm alternative building panel 160 which is similar in features to the building panel 153 except that ends 61 of the formations 60a are not attached to the central section 74.

FIG. 3(k) shows a second 300 mm alternative building panel 161 which is similar in features to the building panel 160 except that one of the formations 60a extends outwardly.

FIG. 3(l) shows a third 300 mm alternative panel 162 which is similar in features to the building panel 161 except that the formations 60a both extend outwardly and the building panel 161 includes a central folded formation 60c.

FIG. 3(m) shows the footing 90 of FIG. 2.

FIG. 3(n) shows a first 90° joiner 100a which comprises a pair of the footings 90a and 90b joined at a 90° angle. The external surface of the side portion 92 of the first footing 90a is joined to the base portion 91 of the second footing 90b, with the base portion 91 of the first footing 90a aligned with the side portion 92 of the second footing 90b. This results in the channels 94 of the footings 90a and 90b being oriented perpendicular to each other.

FIG. 3(o) shows a straight 180° joiner 100b which also comprises a pair of the footings 90a and 90b but joined at a 180° angle. The base portions 91 of the footing 90a and 90b are joined to each other, with the respective side portions 92 and 93 being aligned. This results in the channels 94 of the footings 90a and 90b being aligned and facing opposing directions.

FIG. 3(p) shows a second 90° joiner 100c similar to the joiner 100a but re-oriented by 180°.

FIG. 3(q) shows a 135° joiner 100d which is similar to the joiner 100b except that the base portions 91 of the footings 90a and 90b are angled inwardly at 22.5° towards their respective side portions 92. This results in the channels 94 of the footings 90a and 90b being oriented at 135° relative to each other.

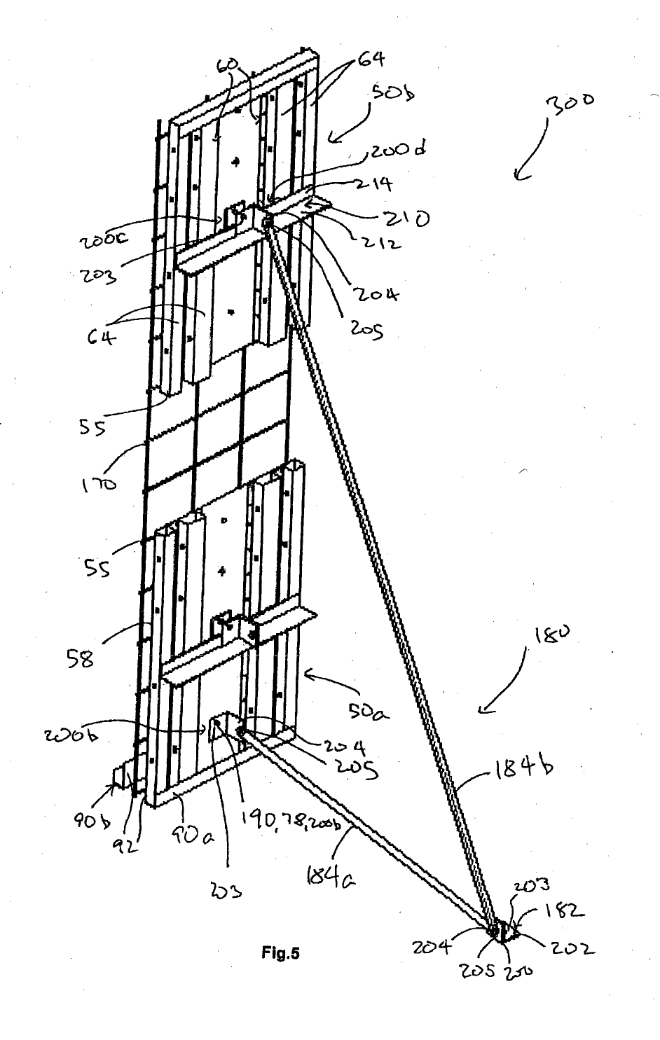

The formation of a wall and a floor slab for a building structure using the building panels 50, footings 90 and joiners 100 will now be described with reference to FIGS. 4 to 10. The steps in forming a building structure using the present building system and method will be described later below with reference to FIGS. 12 to 18.

FIG. 4 shows a first building panel 50a being mounted to a first footing 90a as a first step in building a wall 300 for a building structure 400 according to a preferred embodiment of the present invention. The base portion 91 of the footing 90a is mounted to a concrete floor slab or ground via any suitable means such as by suitable RAMSET™ (registered) fasteners. A lower end 55 of the building panel 50a is inserted into the channel 94 of the mounted footing 90a, with the planar surface 58 being adjacent the first side portion 92.

If desired, the building panel 50 can be attached to the side portion 92 via any suitable fastener means such as spot welding or using a TOG-L-LOC™ (registered) machine.

FIG. 5 shows the building panel 50a mounted to the footing 90a. FIG. 5 also shows a second footing 90b, a second panel 50b, reinforcement mesh 170, and a brace assembly 180.

The second footing 90b is mounted to the floor slab parallel to and spaced from the first footing 90a, with the first side portions 92 parallel and facing each other and having a distance of 60 mm therebetween.

The second panel 50b is shown in the drawing spaced from the first panel 50a for illustration purposes only. The second panel 50b in actual use is attached to the first panel 50a using the 180° joiner 100b with the channels 94 of the joiner 10b receiving the upper end 55 of the first panel 50a and the lower end 55 of the panel 50b. The first and second panels 50a and 50b are attached to the joiner 100b also using suitable fasteners such as spot welding or a TOG-L-LOC® machine.

The building panels 50a and 50b are supported by the brace assembly 180 which comprises an anchor 182 mounted to the floor slab spaced from the first footing 90a, and lower and upper brace struts 184a and 184b respectively attached to the first and second building panels 50a and 50b.

The anchor 182 is typically mounted at a distance of between 200 cm to 400 cm from the first footing 90a. The anchor 182 comprises a first short bracket 200a which is essentially a 90° bent plate having two sides 202 and 204 which are perpendicular to each other. Both sides 202 and 204 include a respective aperture 203 and 205 therein. The anchor 182 is mounted to the floor slab via a fastener inserted through the aperture 203. This positions the other side 204 vertically and first ends of the brace struts 184 are mounted to the side 204 via a threaded rod inserted through the aperture 205 and through apertures in the ends of the brace struts 184. The brace struts can be of any suitable material such as a hollow rod.

The lower brace strut 184a is attached to the first building panel 50a via a threaded rod 190 inserted into one of its central apertures 78a and another short bracket 200b. The threaded rod 190 is inserted into one of the apertures 78a and into the aperture 203 of the short bracket 200b and locked thereto via a nut. The orientation of the side 204 can thus be varied as required, and can be horizontally or vertically oriented. The side 204 is vertically oriented in the embodiment and attached to the lower brace strut 184a via a suitable fastener such as a nut and bolt inserted through the aperture 205 and an aperture at the end of the brace strut 184a.

The upper brace strut 184b is attached to the second building panel 50b also via another threaded rod 190 inserted into one of its central apertures 78a, two short brackets 200c and 200d and a long bracket 210.

The long bracket 210 is essentially similar to the short bracket 200, except that has laterally longer sides 212 and 214 and does not have the apertures 203 and 205. The threaded rod 190 is inserted into one of the apertures 78a the second building panel 50a and into the aperture 203 of the short bracket 200c. The side 204 of the short bracket 200c is oriented horizontally and supports one side 212 of the long bracket 210 with the other side 214 thereof engaging the band portions 64 of the formations 60. The other short bracket 200d is then disposed on top of the side 212 with its side 204 extending vertically, and the threaded rod 190 inserted into its aperture 203 and the three brackets 200c, 210 and 200d locked thereto via a nut. The upper brace strut 184b is then secured via a nut and bolt inserted through the aperture 205 of the short bracket 200d and into an aperture at the end of the upper brace strut 184b.

In actual use, further building panels 50 can be joined laterally to the wall 300 by adding further footings 90 aligned with the footings 90a and 90b. The long bracket 210 will then extend across at least two adjacent building panels 50 for supporting same.

The reinforcement mesh 170 is disposed to be between facing planar surfaces 58 of facing building panels 50. In use, another building panel 50 is mounted to the second footing 90b and will face the building panel 50a. The reinforcement mesh 170 is spaced from the planar surfaces 58 of both building panels 50 via suitable means such as bar chairs such that the reinforcement mesh 170 is disposed substantially halfway between the planar surface 58.

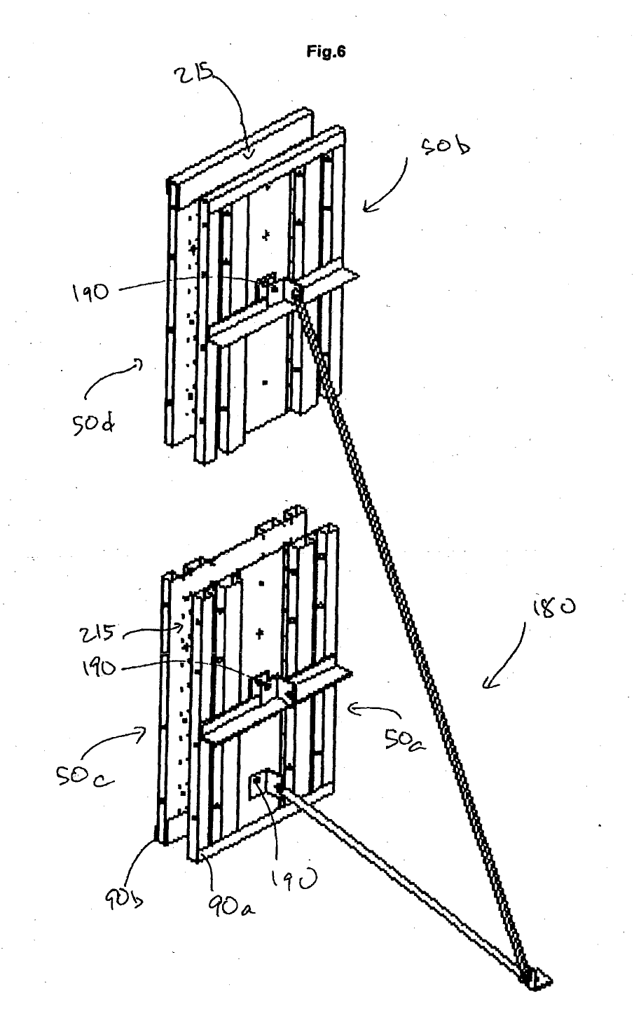

FIG. 6 shows the addition of third and fourth building panels 50c and 50d. the building panel 50c is mounted to the second footing 90b and the fourth building panel 50d is mounted to the third building panel 50c via a joiner 100b. The reinforcement mesh 170 is omitted for illustration purposes only but will be disposed between the building panels 50.

The third and fourth building panels 50c and 50d are supported to the first and second building panels 50a and 50b respectively via the respective threaded rods 190 which attach the first and second building panels 50a and 50b to the brace assembly 180. A respective spacer (not shown) such as a tube piece is received by the threaded rod 190 and disposed between the respective pair of planar surfaces 58 to engage against such surfaces 58 and maintain their spacing. The threaded rod is then inserted into one of the central apertures 78a of the third and fourth building panels 50c and 50d and locked via a nut.

Alternatively or additionally, the third and fourth building panels 50c and 50d are supported to the first and second building panels 50a and 50b via additional threaded rods 190 and spacers inserted through the side apertures 78b.

The spaced building panels 50 define a cavity 215 therebetween within which the reinforcement mesh 170 is disposed.

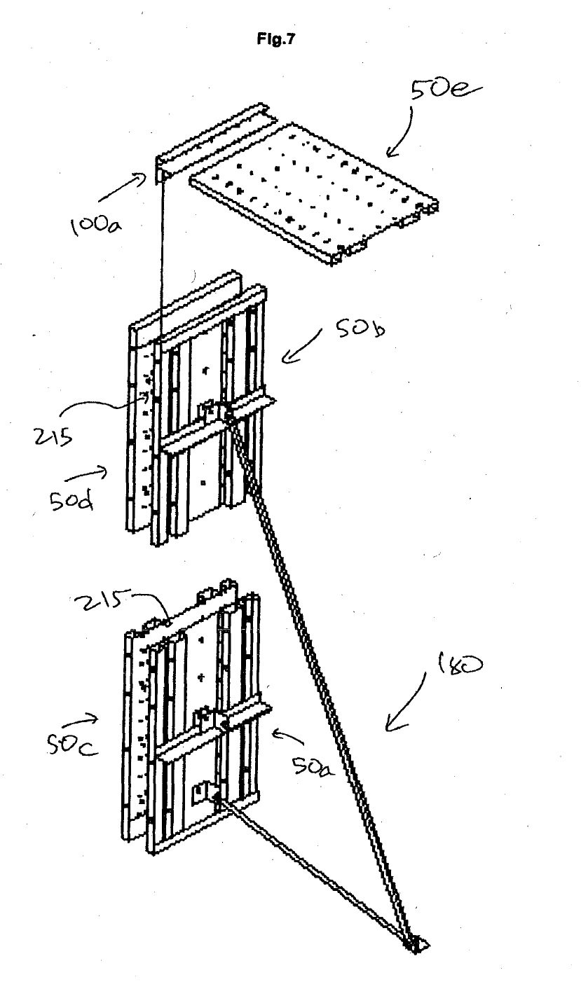

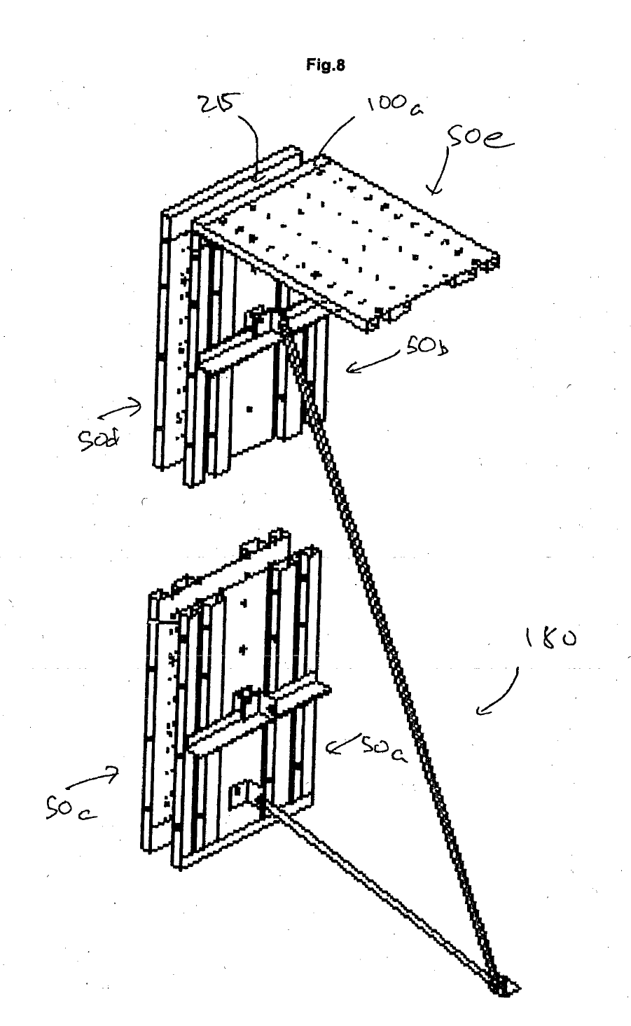

FIGS. 7 and 8 show the addition of a horizontal building panel 50e to the upper end 55 of the building panel 50b via a 90° joiner 100a. The channels 94 of the joiner 100a receive the respective ends 55 of the building panels 50b and 50e which are thus oriented perpendicularly to each other. The building panel 50e can be supported by any suitable structure such as scaffolding.

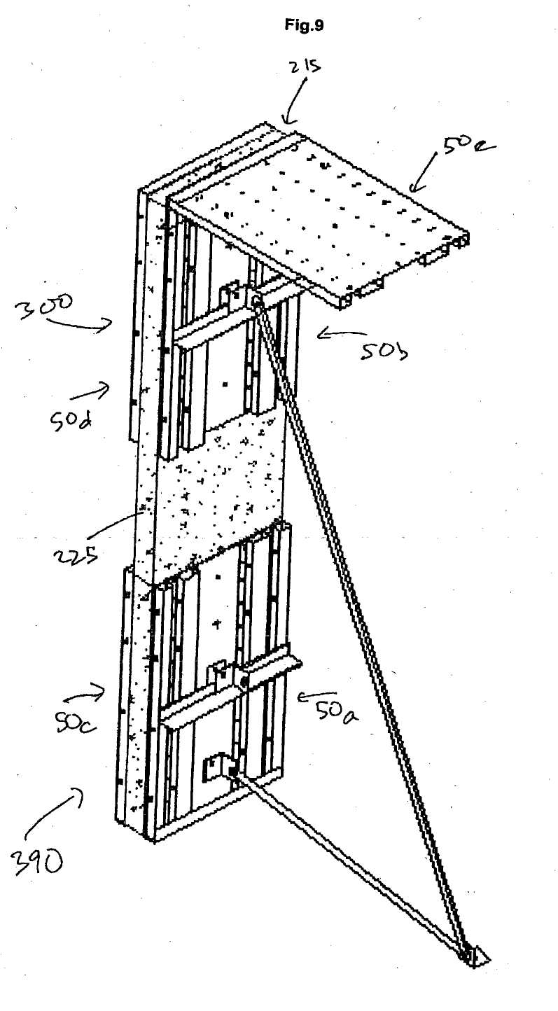

FIG. 9 illustratively shows the result of the first step in pouring concrete into the channel 215 between the building panels 50. The reinforcement mesh 170 and the connection rods 190 are embedded within the poured concrete 225. This forms a wall 300 having a composite structure comprising the building panels 50 on both sides with concrete 225 and the reinforcement mesh 170 therebetween.

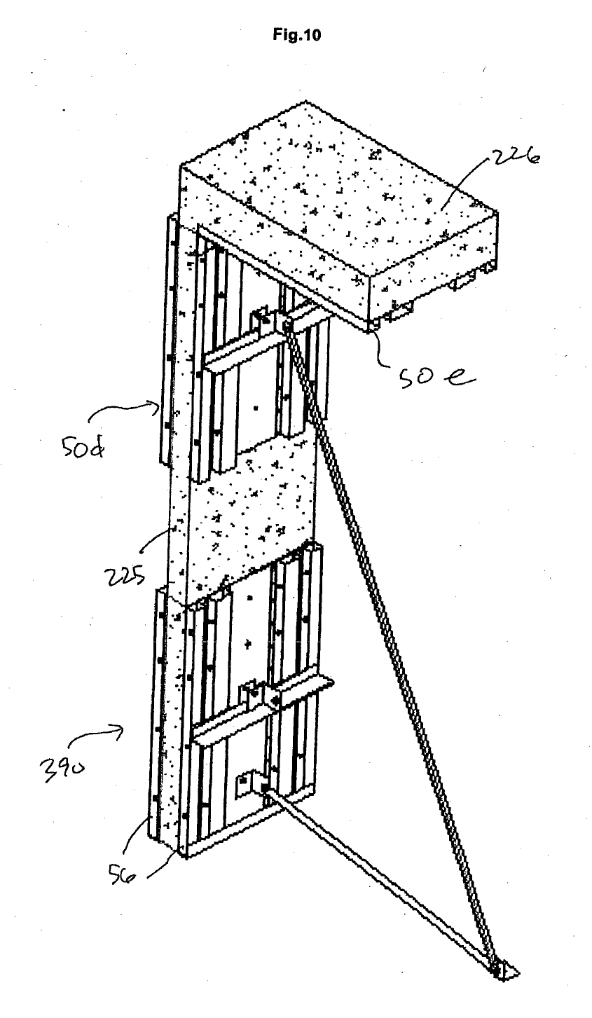

FIG. 10 illustratively shows the result of the next step in pouring concrete on top of the horizontal building panel 50e to form an elevated concrete slab 226. Concrete is poured as required to achieve the desired thickness of the concrete floor slab 226. This forms an elevated floor 305 having a composite structure comprising the building panels 50 on a lower side with concrete slab 226 on top.

The elevated floor 305 can then be used as the base for additional floors of the building structure 400 as described below.

As can be appreciated, FIGS. 9 and 10 are for illustratively showing only the basic concept of the preferred embodiment of the present invention, being the use of the building panels 50, footings 90, joiners 100, threaded rods 190 and reinforcement mesh 170 to form the formwork 390 for concrete for the building structure 400, for forming walls 300 and elevated floors 305. The formwork 390 becomes part of the composite wall 300 and elevated floor 305. The formwork 390 in actual use will include panel members sealing the gap between the lateral edges 56 as required as well as a further panel extending on top of the panel 50d for forming the floor slab 226 (See for example FIG. 28).

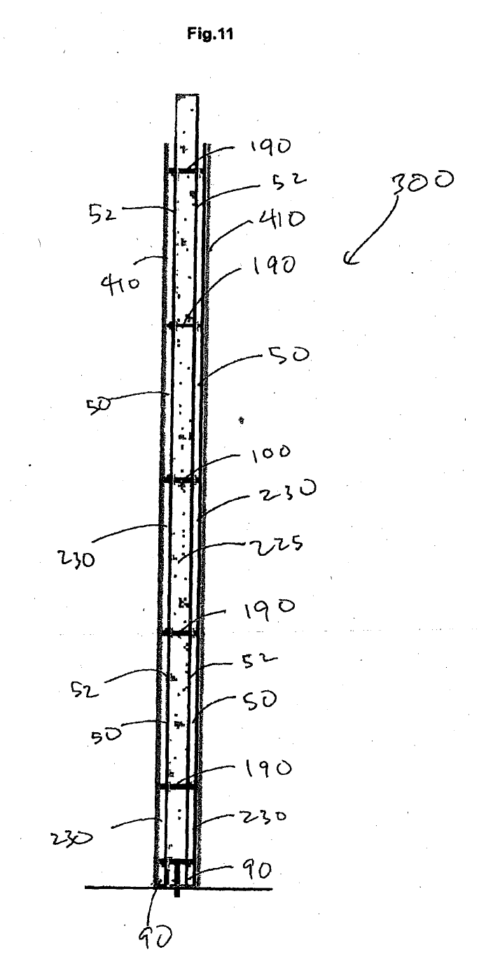

FIG. 11 illustratively shows a cross-section of the wall 300. Once the concrete 225 is set, cladding 410 can be applied to the outer work surfaces of the building panels 50, being the band portions 64.

The cladding 410 can be of any type to provide the required finish, such as Magnesium Oxide wallboards, plasterboard such as GYPROCK™, metal sheets, plywood, a brick wall and the like. Because of the formations 60, the cladding 410 will be spaced from the plate body 52 of the building panels 50 and will form cavities 230 therebetween.

Referring back to FIG. 10, it can be seen that the concrete 225 of the wall 300 and the concrete 226 of the elevated floor 305 will set together to form a generally monolithic structure. With a building structure comprising a ground floor slab, two spaced walls 300 and an elevated floor 305 extending between the spaced walls 300, the preferred embodiment essentially provides a strong box structure with numerous advantages.

The structure of the wall 300 and the elevated floor 305 provides many advantages including one or more of the following:

The composite structure comprising a reinforced concrete wall with the building panels provides a generally thin wall with superior strength compared to traditional wall structures such as those using wooden frames and a brick-veneer structure;

The concrete wall 225 is fireproof and the wall 300 has less fire burning materials;

The formations 60 provide a structure for the attachment of desired cladding, and the cladding is spaced from the concrete wall 225 thus providing an air gap insulation via the cavities 410; and

Services lines can be run through the readily available service line apertures 79 and within the cavities 410.

Further advantages of the present invention will be described and will be apparent from below.

FIGS. 12 to 18 illustratively show the steps in building a building structure 400 according to a preferred embodiment of the present invention.

FIG. 12 shows three spaced wall formwork 390a, 390b and 390c mounted on a ground floor slab 500 supported by footings 502. The formwork 390 is supported by respective brace assemblies 180. The side formwork 390a and 390c each include a respective panel 50f extending upwardly from the external top edges thereof

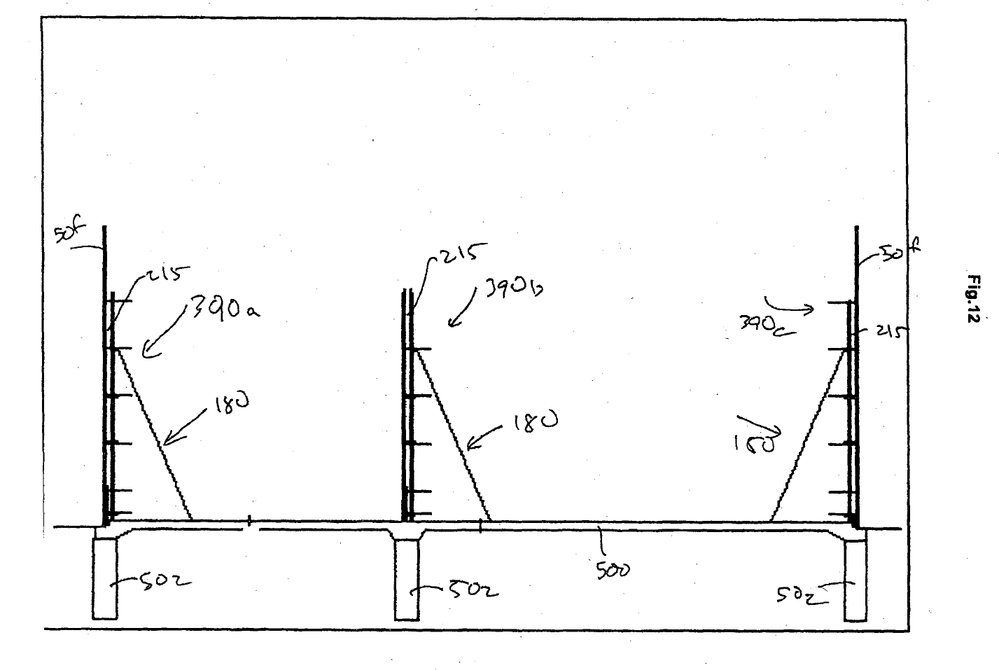

FIG. 13 shows the addition of the horizontal building panels 50e extending between the formwork 390. The building panels 50e are supported by scaffolding 504.

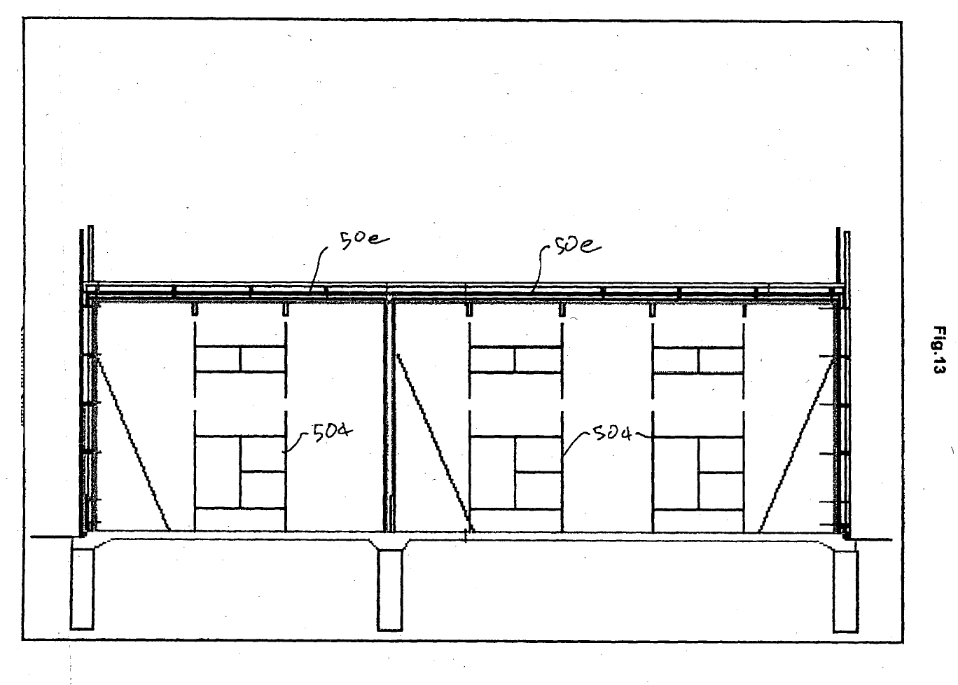

FIG. 14 shows concrete poured into the cavities 215 of the formwork 390 and over the building panels 50e to form the concrete 225 of the walls 300 and the concrete 226 of the elevated floor 305. As mentioned, this concrete sets in one piece to form a monolithic structure.

FIG. 15 shows a worker 512 standing on top of the elevated floor 305. The upwardly extending panels 50f provide instant fall protection for the worker 512. Additional building panels 50g can then be mounted to the elevated floor 305, as well as inclined building panels 50h for forming a pitched roof 302 of the building structure 400. The panels 50h are joined to the panels 50g using the 135° joiners 100d.

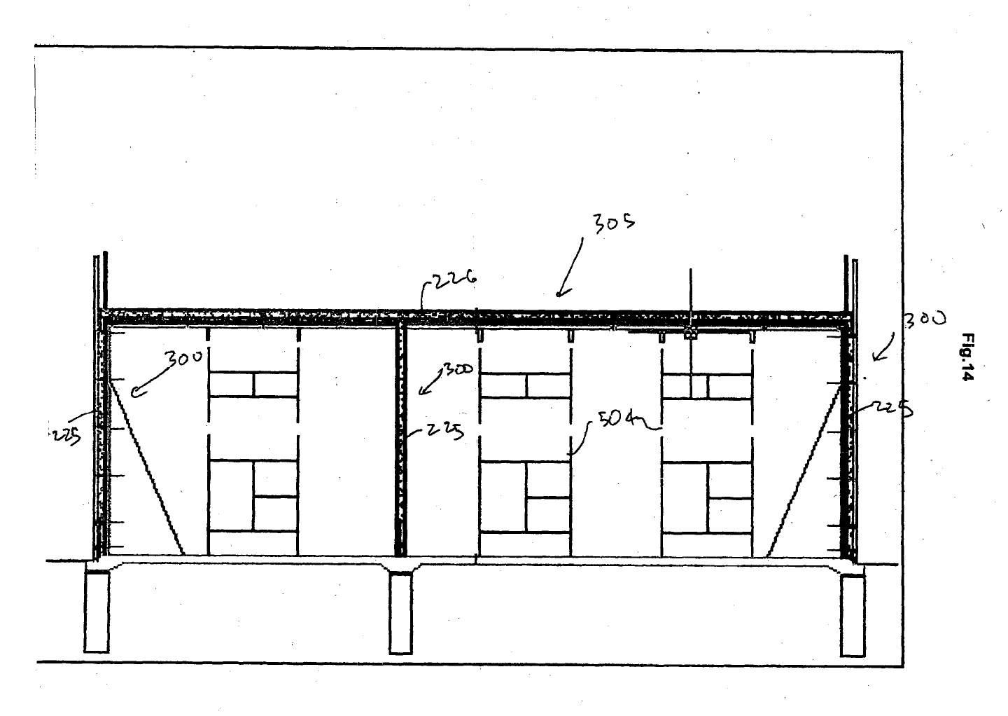

FIG. 16 shows the addition of further building panels 50h and building panels 50m. The building panels 50h complete the inner formwork structure for the roof 302 and the building panels 50m are spaced from the building panels 50h using threaded rods and spacers, forming a cavity 215 therebetween. These panels are supported by braces 506.

In forming the formwork for the building structure 400, any of the building panels 50 and 152 to 162 and joiners 100 can be used as required depending on the width requirements. The half-panels 157 to 159 for example can be used for the angled portions of the walls where one side may need to be cut and does not require the formations 60.

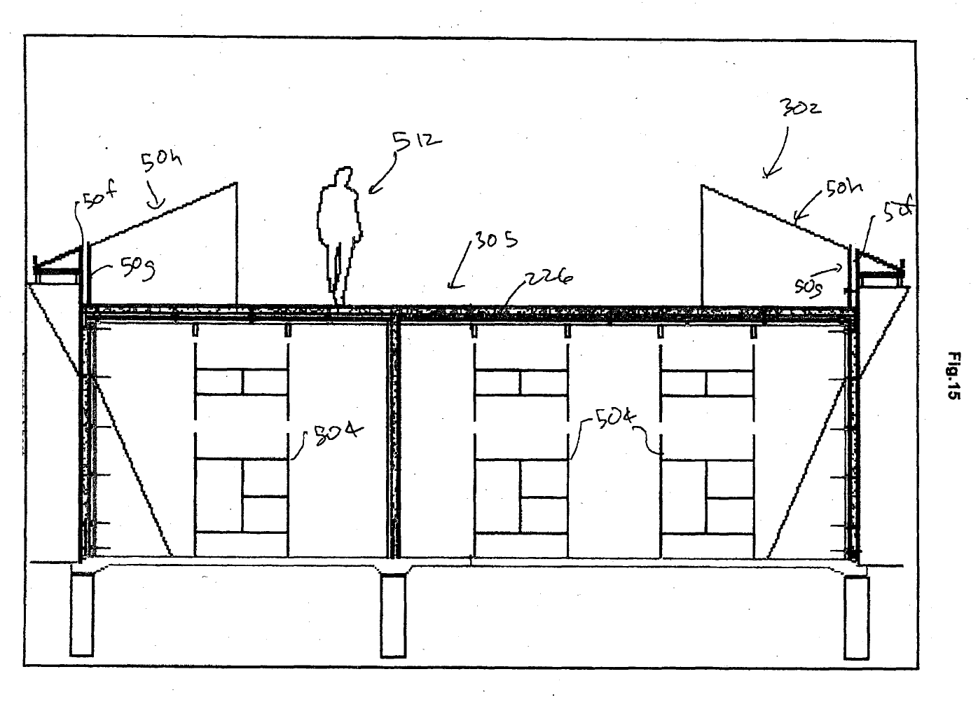

FIG. 17 shows the building structure 400 after concrete 227 is poured into the cavity 215 for the roof 302 and between the panels 50f and 50g to form the roof 302 and an upper level wall 430. The braces 506 are then removed.

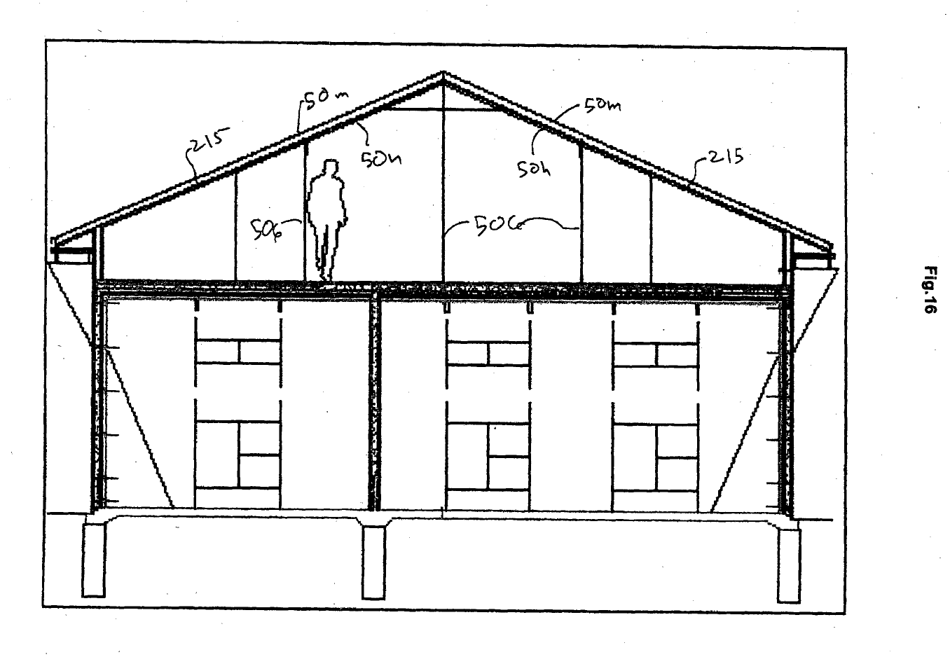

FIG. 18 shows the finished building structure 400 with cladding 410 attached to the outer surfaces of the walls 300. The cladding can be a brick wall 415 attached to the building panels 50 via brick ties or any desired cladding panel 410.

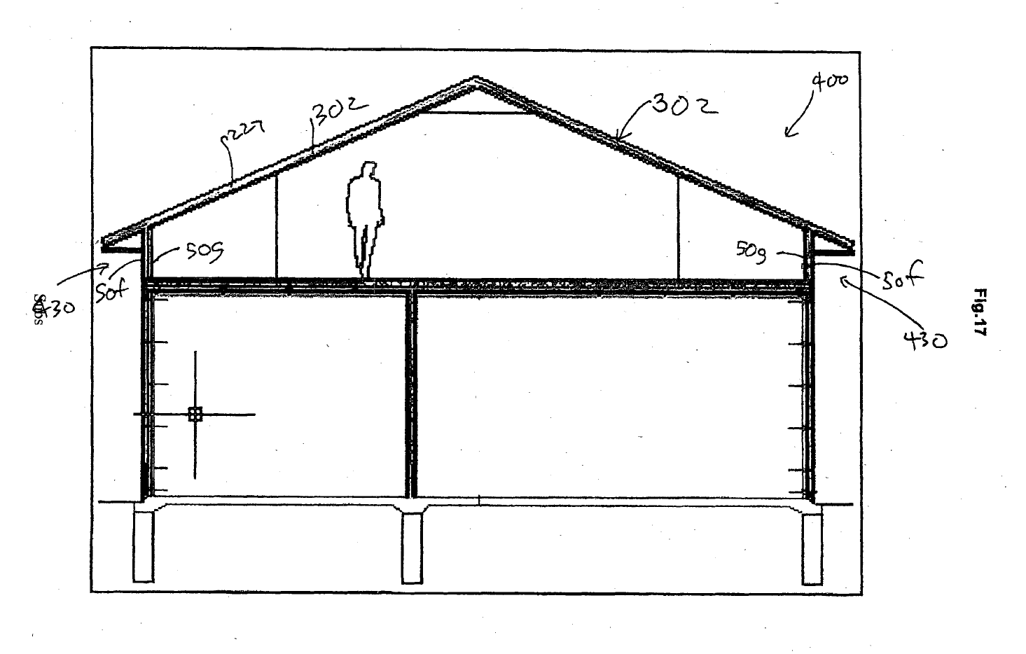

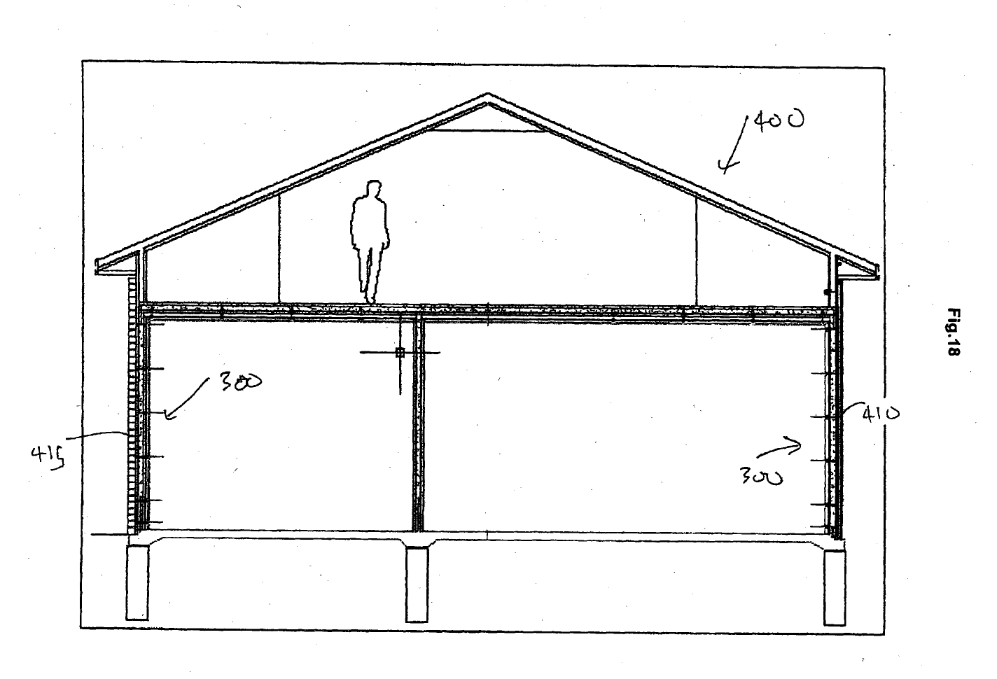

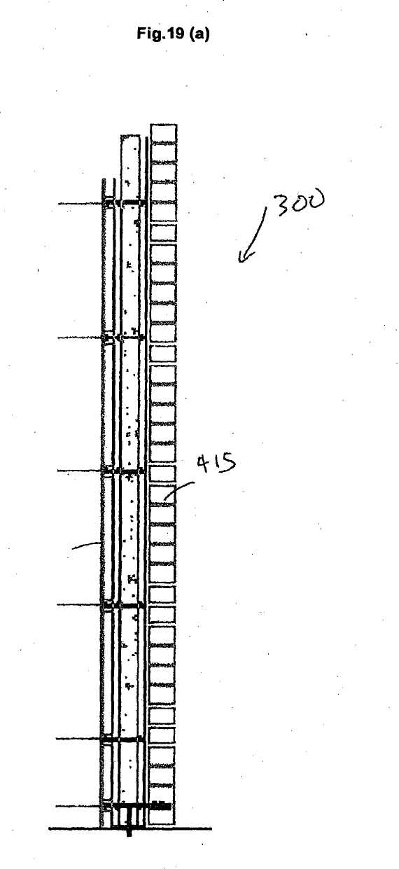

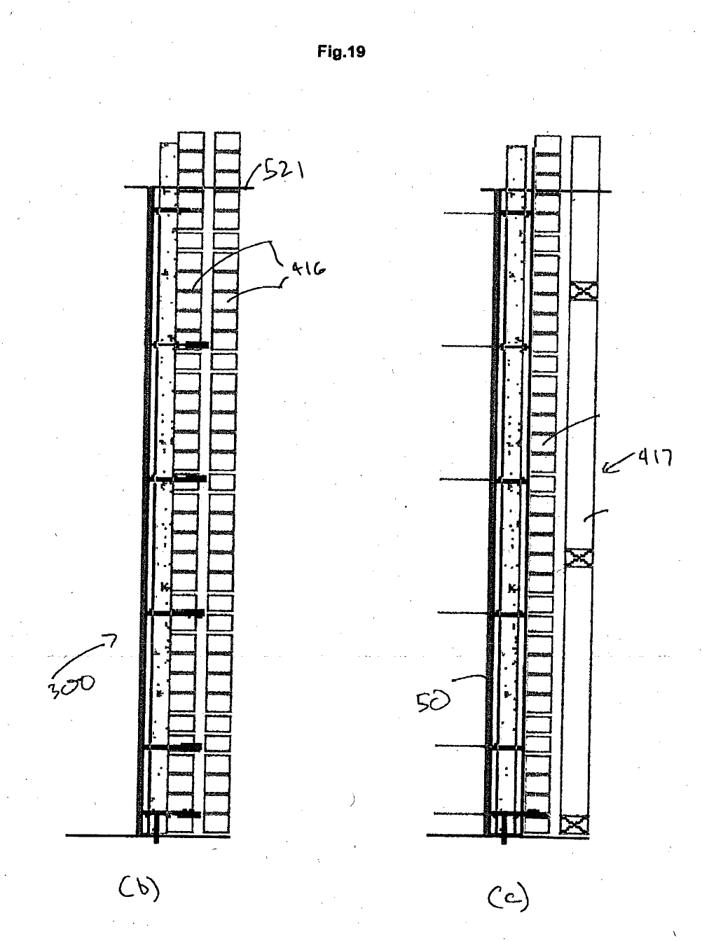

FIG. 19(a) shows a first alternative wall structure to that shown in FIG. 11. As described, any desired cladding or wall covering can be attached to the building panels 50. In this embodiment, one side is covered by a brick wall 415 while the other side is covered by cladding panel 410.

FIG. 19(b) shows a second alternative wall structure. In this embodiment, one side is covered by a double brick wall 416. This structure can be used for strengthening existing double brick wall structures which may be required for older structures. The building panels on one side of the wall 300 are attached to the existing wall via brick ties 521, with the other building panels then mounted to the ground as required and concrete poured therebetween. This can also be used to provide a new external or internal look to such building structures as the other side of the wall 300 can be covered with cladding of the desired finish.

FIG. 19(c) is similar to the structure of FIG. 19(b) except it is for a brick veneer wall 417. As above, this structure can be used for strengthening existing brick veneer wall structures and providing a new external look to such building structures with new cladding.

FIG. 19(d) is similar to that shown in FIG. 19(b).

FIG. 19(e) provides another alternative structure where the external building panels 50 are removed from the wall 300 after the concrete is set. This provides a strengthened double brick wall with a new external look.

FIG. 28 illustratively shows the formwork 390 and horizontal panels 50e as already referred to above.

FIG. 29 shows an example of a finished building structure 400 according to the preferred embodiment being a granny flat (secondary suite). In Australia, such granny flats can be constructed without requiring development approval if they cover less than 60 m2 footprint. The structure 400 is 10 meters wide and 6 meters in depth. If traditional building methods are used, such granny flat structures are limited to a single level as such traditional structures cannot provide sufficient support for upper levels. The structure of the walls and the elevated floor slab of the present embodiment however provides sufficient support for adding an additional floor level to such structures. As such, a two or more level structure can be erected using the same footprint.

FIG. 30 shows an alternative use of the building panels of the present invention as a bushfire (wildfire) shield. The planar surfaces 58 of the building panels 50 can be coated with a fire/heat resistant coating such as TEFLON™. In use, emergency services can erect a number of the building panels 50 with the coated planar surfaces 58 facing outwardly to the oncoming direction of the fire. In such cases, the building panels 50 are used to dissipate the heat around the structure to minimise or reduce the combustibility of the building structure.

Whilst preferred embodiments of the present invention have been described, it will be apparent to skilled persons that modifications can be made to the embodiments described. For example, the building panels 50 can be made to have curved planar surfaces 58 which will allow curved walls to be formed.

In other possible modifications, the planar surfaces 58 can include formations therein to assist with bonding or attachment to the concrete, such as stippling, a roughened surface, protrusions and projections.

Also, the building panels can be colour-coded for easy assembly. As shown in FIG. 28, internal vertical building panels can be blue, external building panels can be yellow and the horizontal building panels can be green which assists workers during assembly.

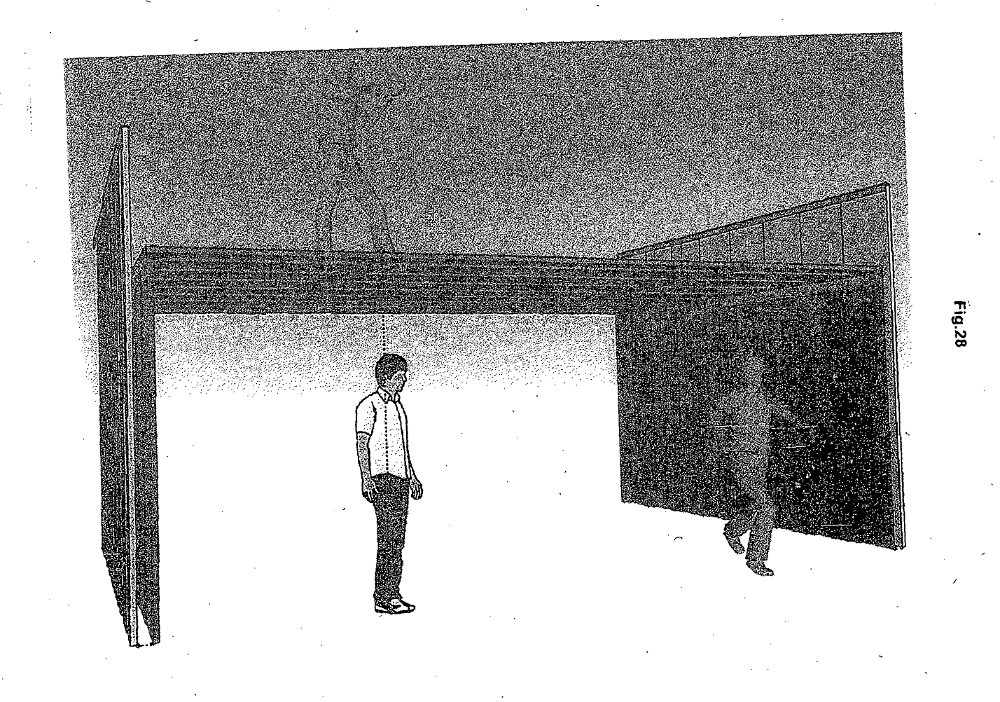

FIG. 31 shows a stair step building panel 700 and a stair side form panel 702. These panels are generally similar to the building panels 153 above. However, for the step panel 700, the side portions 62 extend at an inclined angle relative to the band portion 64 and the plate body 52. This results in the plate body 52 being at an inclined angle when the stair panel 700 is rested on one of its side portions 62.

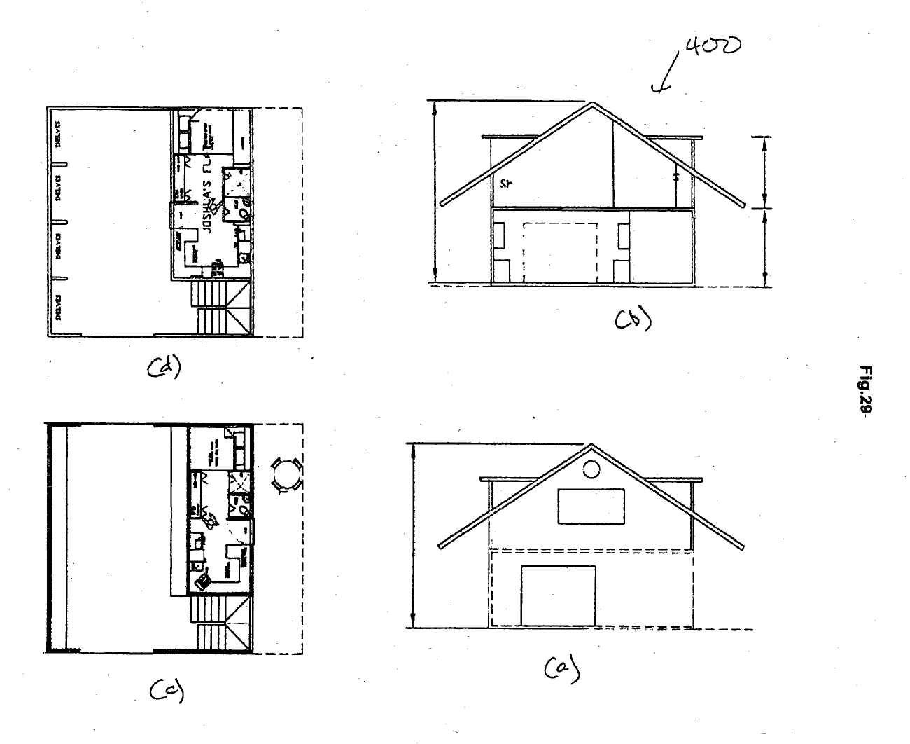

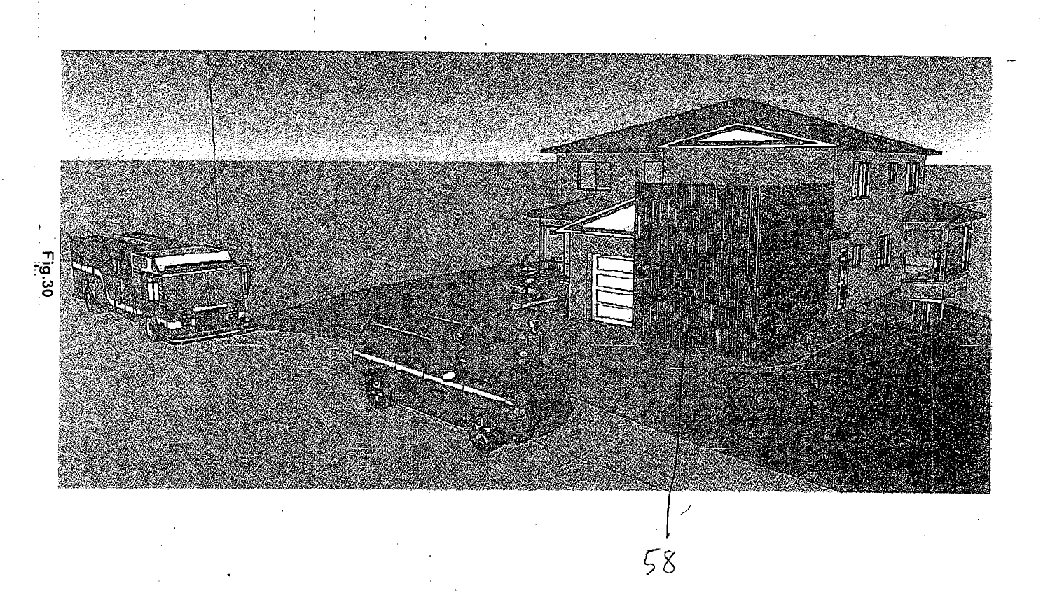

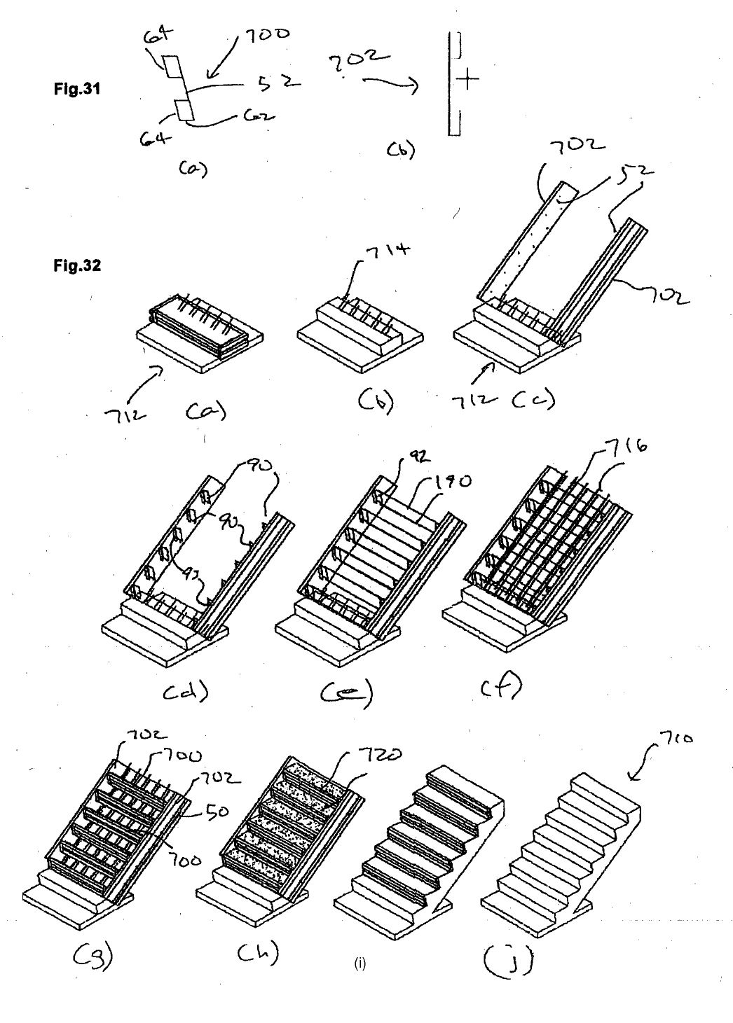

FIG. 32 (a) to (j) show the steps in building stairs 710 using the building panels of FIG. 31. The steps are as follows:

A stair base 712 is formed.

Dowel bars 714 are set into the stair base 712.

Side form panels 702 are mounted at an inclined angle to the stair base 712, with the plate bodies 52 facing each other.

J-shaped connectors 90 (similar to the footings 90) are mounted in spaced pairs to the side form panel 702, with the channels 94 extending vertically and the second side portions 93 facing the bottom of the stairs.

Threaded bar connectors 190 are installed between the side form panels 702, in spaced pairs extending between the first side portions 92 of the connectors 90.

Stair reinforcing bars 716 are installed extending across the threaded bar connectors 190.

Stair panels 700 are installed between the connectors 90, with the plate bodies 52 facing the top of the stairs. A building panel 50 is also installed below and extending between the side form panels 702. The building panel 50 is retained in position by the dowel bars 714.

Concrete 720 is poured.

The side form panel 702 are then removed.

Shows finished stairs 710, with the stair panels 700 removed or covered with cladding.

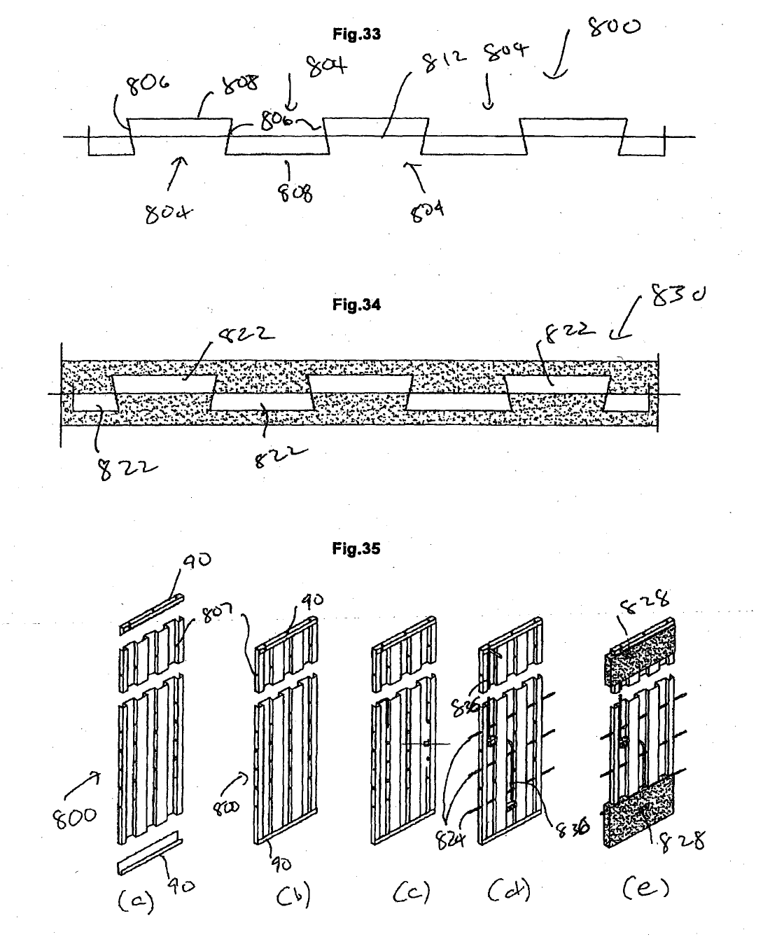

FIG. 33 shows an end view of an internal partition building panel 800 with a reinforcing bar 812. This building panel comprises a body 802 which is generally corrugated, having spaced dovetail shaped channels 804 formed therein. Adjacent channels 804 face alternating sides of the body 802.

Each channel 804 is defined by side portions 806 and a band portion 808, with the side portion 806 of one channel 804 forming the side portion 806 of an adjacent channel 804 which faces the other direction. For each channel 804, the side portions diverge to the band portion 808 forming a dovetail channel shape.

The side portions 806 comprise apertures 807 formed therein for receiving reinforcement bars 812 which extend laterally across the building panel 800.

FIG. 35 (a) to (e) show the steps in building an internal partition 830 (FIG. 34) using the building panel of FIG. 33. The steps are as follows:

Top and bottom J-track footings 90 are mounted to the floor and ceiling of the building structure.

Internal partition building panel 800 is mounted to the footings 90.

Cavity spacers 822 are disposed in the channels 804. Each spacer 822 extends generally from the band portion 808 to the apertures 807. The cavity spacers 822 are preferably extruded polystyrene foam such as Styrofoam®. The spacers 822 are also dovetail shaped.

Reinforcing bars 824 are installed across the apertures 807 as required. Services 836 are run across the channels 804 as required.

The building panel 800 is rendered using Shotcrete method, Gunite® or Light weight foam concrete 828 to form the finished internal partition 830.

FIG. 36 shows an end view of an external render building panel 840 with a reinforcing bar 812. This building panel is similar to the building panel 800 and includes spaced dovetail shaped channels 804.

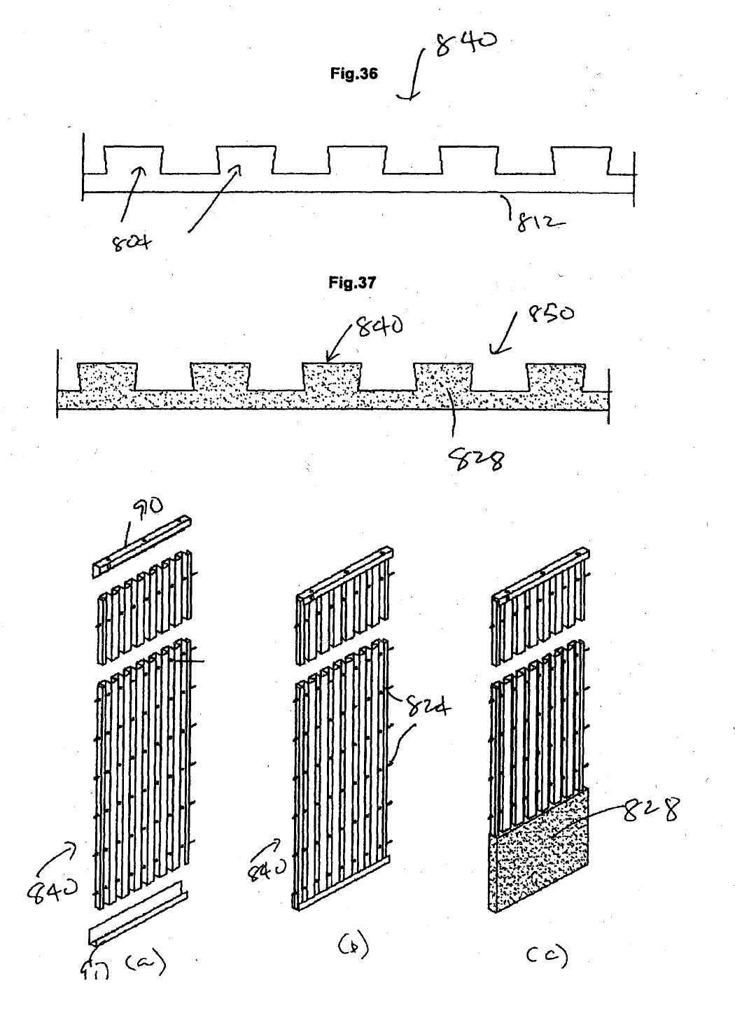

FIG. 38 (a) to (c) show the steps in building an external render 850 (FIG. 37) using the building panel of FIG. 36. The steps are as follows:

Top and bottom J-track footings 90 are mounted to the floor and ceiling of the building structure and external render building panel 840 is mounted to the footings 90. Alternatively, the external render building panel 840 is mounted to an external cladding or building panel.

Reinforcing bars 824 are installed across the apertures 807 as required.

The exposed side is rendered using Shotcrete method, Gunite® or Light weight foam concrete 828 to form the finished external render 850.

It can be seen that the present embodiments provide many alternative and advantages including one or more of the following:

The building panels are rolled formed or process metal sheets or fiber reinforced plastic or other material sheet to form formations which define a unique cavity space with the cladding that are designed to be use as air gap cavity, services run, batten frame for the cladding and other uses;

The building panels use simple joiners for quick and easy installation;

The building panels use typical and cheap threaded rod system designed to provide a simple fixing system that utilizes the use of low technology tools;

The building panels joint fixing are designed for easy fixing and joining on site;

The building panels are pre-engineered and pre-manufactured from architectural and structural plans for new structures and out of existing building layout plan to minimize cost of on-site extra work and to maximize the quality design and construction monitoring;

The building panels are provided in pre-manufactured lengths with pre designed drilled holes;

The building panels can be manufactured to provide curved surfaces for use in curved walls, curved roofs, and splayed concrete structure;

The building panels can be designed and produced using CAE/CAM system on roll forming or other processes based on the architectural and structural plans of new and existing buildings;

The building panels are assembled on site based on prepared assembly plans and instruction manual;

The present building system provides quick installation and assembly;

The present building system addresses a number of building compliance regulation (e.g. termite protection, damp protection, sound insulation, fire hazard reduction, fire separation, strength and durability);

The present building system can be used for both exterior and interior building structure use and for strengthening existing structures as well as providing a new look;

The present building system can be used for concrete walls, columns, beams and concrete slabs that are permanent;

The present building system provides a double sided composite system for concrete walls and single sided composite system for concrete floor slabs. Composite action provides robust concrete walls and flexural strength improvement to the concrete wall;

The present building system minimises the concrete wall thickness required due to the increased flexural strength and lower slender, thus providing a concrete thin plate walls and pitched roof plate system;

The present building system allows for services runs (such as water line and electrical lines) along the service apertures of the rib formations 60;

The building panels can be used as stiffeners and battens or studs framing for internal and external cladding. This minimises if not eliminates the use of timber battens that serves a fuel material for fire;

The building panels provides thermal insulation spaces between the rib cage formations 60;

The building panels provide ribbed surface corrugation that increases sound absorption and dispersion;

The building panels provide a low damage and shielding barrier against cracked and spalling concrete structures in case of a catastrophic building collapse due to an extreme natural event such as an earthquake, tsunami, tornado, or hurricane;

The building panels provide a complete hold down plate or tie down plate system to the building structures, as well as self bracing and propping system feature;

The present building system and building panels can be used as parapet cladding support frame, innovative and simplified shed or storage system, property fence, safety barrier and guard rails, signage frame, advertisement panel frame;

The building panels provides air gap insulation on either side of a concrete wall which allows heated air to be removed at the external skin and provides a better heated or cooled air containment for building air conditioning;

The present building system provides a simplified formwork assembly and connection that allows monolithic concreting of walls and slab of building structures;

The present building system provides a double composite action in structural engineering which provides a unique flexural and additional axial and shear strength to a concrete wall; and

The threaded rod fixing can be used as supports for heavy cladding (e.g. brickwork and stone wall cladding), mechanical equipment, awning fixing, frame fixing for extension as well as temporary framing for safety access and barriers.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the building industries.

1. A building panel, comprising:
a substantially planar first side; and
a second side having at least one formation, each formation comprising a respective work surface spaced from the first side.

2. The building panel of claim 1, further comprising:
a plate body having a first side and an opposite second side, wherein said at least one formation extends from the second side.

3. The building panel of claim 1 wherein the first side has a profile selected from a group consisting of: a flat planar surface and a curved surface.

4. (canceled)

5. The building panel of claim 1, wherein each formation comprises an elongated formation.

6. The building panel of claim 1, wherein each formation comprises a longitudinal formation.

7. The building panel of claim 6, further comprising:
at least two spaced longitudinal formations extending along the second side.

8. The building panel of claim 7, wherein the at least two spaced longitudinal formations are parallel.

9. The building panel of claim 7, further comprising:
a plate body having a first side and an opposite second side, wherein said at least one formation extends from the second side,
wherein each formation extends between ends of said plate body and spaced laterally between lateral edges of said plate body.

10. The building panel of claim 9, wherein the formations are disposed symmetrically about a center line extending between ends of said plate body.

11. The building panel of claim 9, wherein the formations comprise two first formations adjacent the respective lateral edges of the plate body.

12. The building panel of claim 11, wherein the formations further comprise two second formations respectively spaced inwardly from the first formations.

13. The building panel of claim 6, wherein each longitudinal formation comprises a channel section having spaced side portions extending from the second side and a band portion extending between the side portions, the band portion defining the work surface.

14. The building panel of claim 13 wherein the side portions extend in one orientation of a group consisting of: substantially perpendicularly from the second side, substantially diverging manner from the second side, and substantially converging manner from the second side.

15-17. (canceled)

18. The building panel of claim 13, wherein the band portion is substantially parallel to the first side.

19. The building panel of claim 1, further comprising:
a plurality of spaced apertures formed in the building panel extending from the first side to the second side.

20-21. (canceled)

22. The building panel of claim 13, further comprising:
at least one service line aperture formed in the at least one formation, the service line aperture extending in a generally lateral direction of the panel.

23. The building panel of claim 22, wherein the at least one service line aperture is formed in the side portions of the formations.

24-28. (canceled)

29. The building panel of claim 1, further comprising:
a plurality of spaced work surfaces.

30-33. (canceled)

34. The building panel of claim 1 being formed by a single piece of folded panel material.

35. A building system comprising:
at least one building panel according to claim 1;
an elongated footing having a channel for receiving an end portion of the at least one building panel;
a panel joiner defining first and second outwardly directed channels oriented perpendicularly to each other;
a panel joiner defining first and second outwardly directed channels oriented at generally opposing directions; and
a panel joiner defining first and second outwardly directed channels oriented at about 135° relative to each other.

36-39. (canceled)

40. A method of building a wall, the method comprising the steps of:
assembling a building system according to claim 35; and
mounting to a first footing to a concrete floor slab or ground;
mounting a first building panel into the first footing;
mounting a second footing to the concrete floor slab or ground, spaced and substantially parallel to the first footing;
mounting a second building panel into the second footing, the first side of the second panel facing the first side of the first panel; and
joining the first and second building panels via at least one joining rod,
wherein each joining rod comprises a threaded rod and a spacer received by said threaded rod disposed between the building panels.

41-60. (canceled)
